(19) United States
(12) Patent Application Publication
(10) Pub. No.: US 2025/0091654 A1
(43) Pub. Date: Mar. 20, 2025

(54) JOINT STRUCTURE OF VEHICLE BODY

(71) Applicants: Hyundai Motor Company, Seoul (KR); Kia Corporation, Seoul (KR)

(72) Inventors: Won Ki Song, Hwaseong-si (KR); Yongbai Joo, Hwaseong-si (KR); Joonghyun Shin, Hwaseong-si (KR); Jaeseung Lee, Hwaseong-si (KR); Jungsuk Lee, Hwaseong-si (KR); Byung Jin Son, Hwaseong-si (KR); Dae Hee Lee, Hwaseong-si (KR); Jin Ho Hwang, Hwaseong-si (KR); Chulhee Heo, Hwaseong-si (KR); Hyungsik Choi, Hwaseong-si (KR)

(21) Appl. No.: 18/819,036

(22) Filed: Aug. 29, 2024

(30) Foreign Application Priority Data
Sep. 20, 2023 (KR) 10-2023-0125385

(51) Int. Cl. B62D 25/08; B62D 25/04; B62D 27/02

(52) U.S. Cl. CPC B62D 25/08; B62D 25/04; B62D 27/02

(57) ABSTRACT

An embodiment joint structure of a vehicle body includes a front body module including a fixed part fixed to a front part of an under body, a rear body module including a variable part detachably coupled to a rear part of the under body and a rear part of the front body module, the rear body module having a predetermined shape, fixed part joints disposed at a rear edge of the front body module and at a rear of the under body, variable part joints disposed on a front edge and a rear lower part of the rear body module and connected with the fixed part joints, and a joint mounting reinforcement unit disposed on a lower inner side of a rear pillar assembly disposed on both sides of the rear part of the rear body module and connected with the variable part joints.

### CROSS-REFERENCE TO RELATED APPLICATIONS

This application claims the benefit of Korean Patent Application No. 10-2023-0125385, filed on Sep. 20, 2023, which application is hereby incorporated herein by reference.

### TECHNICAL FIELD

The present invention relates to a vehicle body.

### BACKGROUND

Recently, the vehicle industry is introducing a new concept of future mobility vision for realizing a human-centered, dynamic future city. One of these future mobility solutions is a purpose built vehicle (PBV) as a purpose-based mobility.

A PBV can be an example of an electric vehicle (EV)-based environment-friendly mobile vehicle. The PBV can provide various customized services to users while moving from the starting point to the destination in an unmanned autonomous driving method.

The vehicle body of such a PBV is composed of an under body (also referred to as a rolling chassis or a skateboard in the art) and an upper body assembled to the under body.

Here, the upper body may be configured in various forms according to the type of customized service of the PBV. For example, the PBV can be used as a hailing type vehicle having cabins respectively configured in the front and rear parts of the upper body. Furthermore, the PBV may be used as a cab type vehicle in which a cabin is configured only in the front portion of the upper body. Furthermore, the PBV may be used as a delivery type vehicle in which a cabin is configured in the front part of the upper body and a luggage room is configured in the rear part.

As described above, the cost of changing the structure of the upper body may increase according to various customized services of the PBV.

Matters described in this background section are prepared to enhance understanding of the background of embodiments of the invention and may include matters other than already known prior art.

### SUMMARY

The present invention relates to a vehicle body. Particular embodiments relate to a joint structure of a vehicle body of a PBV.

Embodiments of the present disclosure provide a joint structure of a vehicle body that can be replaced with various types of vehicle bodies according to the type of customized service of the PBV.

A joint structure of a vehicle body according to an exemplary embodiment may include a front body module as a fixed part fixed to a front part of an under body, a rear body module as a variable part attachable and detachable to a rear part of the under body and a rear part of the front body module with a predetermined shape, fixed part joints installed at a rear edge of the front body module and at a rear of the under body, variable part joints installed on a front edge and a rear lower part of the rear body module and connected with the fixed part joints, and a joint mounting reinforcement unit mounted on a lower inner side of a rear pillar assembly provided on both sides of the rear part of the rear body module and connected with the variable part joints.

The rear pillar assembly may include a pillar inner member and a pillar outer member connected together.

The joint mounting reinforcement unit may be connected to inner surfaces of the pillar inner member and the pillar outer member.

The joint structure of a vehicle body according to an exemplary embodiment may further include a mount bracket connected to a side of the under body and on which the fixed part joints provided at the rear of the under body are mounted.

The joint mounting reinforcement unit may include a reinforcement member connected to inner surfaces of a pillar inner member and a pillar outer member on a lower inner side of the rear pillar assembly including the pillar inner member and the pillar outer member connected together, and connected with the variable part joints, and a lower support member connected to a lower part of the reinforcement member and connected to the pillar inner member and the pillar outer member.

The reinforcement member may include a joint combined section where the variable part joints are combined, and fastening members may be mounted on the joint combined section.

The reinforcement member may include pillar combined flanges formed on edge portions to be connected with the inner surfaces of the pillar inner member and the pillar outer member.

One of the pillar combined flanges may overlap with the pillar outer member and the lower support member and may be provided as a tail gate mount portion that engages with a tail gate assembly.

The joint structure of a vehicle body according to an exemplary embodiment may further include fastening members installed in the tail gate mount portion.

The lower support member may include a first combined flange portion combined with the lower part of the reinforcement member, a second combined flange portion combined with the pillar inner member, and a third combined flange portion combined with the pillar outer member.

The joint structure of a vehicle body according to an exemplary embodiment may further include a back panel disposed along the vehicle width direction at the rear lower part of the rear body module and to which the lower support member is connected.

The joint structure of a vehicle body according to an exemplary embodiment may further include a wheel house inner member provided on the rear side of the rear body module, and to which the lower support member is connected.

The joint structure of a vehicle body according to an exemplary embodiment may further include a back panel extension member that is connected to a back panel disposed along the vehicle width direction at the rear lower part of the rear body module and is connected to a pillar inner member of the rear pillar assembly.

According to exemplary embodiments of the present invention, cost reduction can be achieved by changing the upper body structure of the vehicle body to suit various customized services of the PBV.

Additionally, embodiments of the present invention can secure the combined strength and skeletal strength of the front body module and the rear body module that are detachable from each other.

In addition, the effects that can be obtained or predicted due to the embodiments of the present invention will be directly or implicitly disclosed in the detailed description of the embodiments of the present invention. That is, various effects expected according to an embodiment of the present invention will be disclosed within the detailed description to be described later.

### BRIEF DESCRIPTION OF THE DRAWINGS

Since these drawings are for reference in explaining exemplary embodiments of the present invention, the technical idea of the embodiments of the present invention should not be construed as being limited to the accompanying drawings.

FIG. 1 is an exploded perspective view showing a vehicle body joint structure according to an exemplary embodiment.

FIG. 2 is an exploded perspective view showing a front body module and a rear body module applied to the vehicle body joint structure according to an exemplary embodiment.

FIG. 3 is an exploded perspective view of the rear body module and an under body applied to the vehicle body joint structure according to an exemplary embodiment.

FIG. 4 is a cross-sectional view of the rear body module and the under body applied to the vehicle body joint structure according to an exemplary embodiment.

FIG. 5 and FIG. 6 are perspective views showing a joint mounting reinforcement unit applied to the vehicle body joint structure according to an exemplary embodiment.

FIG. 7 is an enlarged drawing of the joint mounting reinforcement unit applied to the vehicle body joint structure according to an exemplary embodiment.

FIG. 8 is an exploded perspective view showing the joint mounting reinforcement unit applied to the vehicle body joint structure according to an exemplary embodiment.

FIG. 9A to FIG. 10B are drawings showing a reinforcement member and a lower support member of the joint mounting reinforcement unit applied to the vehicle body joint structure according to an exemplary embodiment.

FIG. 11 is a cross-sectional view along line A-A in FIG. 3.

FIG. 12 is a cross-sectional view along line B-B in FIG. 3.

The following reference identifiers may be used in connection with the drawings to describe various features of embodiments of the present invention.

| | |
|---|---|
| 1: under body | 3: upper body |
| 5: tail gate assembly | 7: hinge mechanism |
| 10: front body module | 10a: fixed part |
| 20: rear body module | 20a: variable part |
| 21: rear pillar assembly | 23: pillar inner member |
| 25: pillar outer member | 27: wheel house inner member |
| 28: back panel | 29: back panel extension member |
| 30: joint unit | 31: fixed part joint |
| 33: mount bracket | 35: variable part joint |
| 50: joint mounting reinforcement unit | 51: reinforcement member |
| 53: joint combined section | 55, 61: fastening member |
| 55a, 61a: weld nut | 55b: bolt |
| 57: pillar combined flange | 59: tail gate mount portion |
| 71: lower support member | 73: first combined flange portion |
| 75: second combined flange portion | 77: third combined flange portion |
| 100: vehicle body joint structure | |

The drawings referenced above are not necessarily drawn to scale and should be understood as presenting a rather simplified representation of various preferred features illustrating the basic principles of embodiments of the invention. The specific design features of embodiments of the invention, including, for example, specific dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that those skilled in the art can easily implement the present invention. As those skilled in the art would realize, the described embodiments may be modified in various different ways, all without departing from the spirit or scope of the present invention.

The terminology used herein is for the purpose of describing specific exemplary embodiments only and is not intended to limit the present disclosure. As used herein, the singular forms are intended to include the plural forms as well, unless the context clearly indicates otherwise.

The terms ‘comprises’ and/or ‘comprising’ as used herein indicate the presence of specified features, integers, steps, operations, elements and/or components, but they do not exclude the presence or addition of one or more other features, integers, steps, operations, components, and/or groups thereof.

As used in this specification, the term ‘and/or’ includes any one or all combinations of at least one of the associated listed items.

In this specification, the term ‘connected’ indicates that a physical relationship between two components, for example, in which components are directly connected to each other by welding, self piercing rivet (SPR), flow drill screw (FDS), structural adhesive, or the like or components that are indirectly connected through one or more intermediate components.

As used herein, ‘vehicle,’ ‘vehicular,’ ‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles, and other alternative fuel vehicles (e.g., other than petroleum fuel derived from resources).

Hereinafter, embodiments of the present invention will be described in detail with reference to the accompanying drawings.

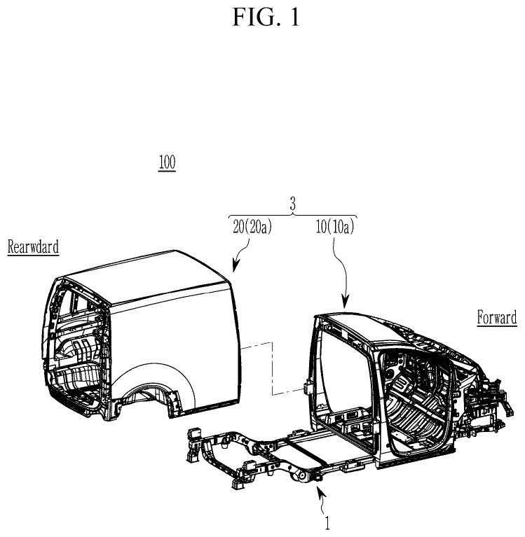

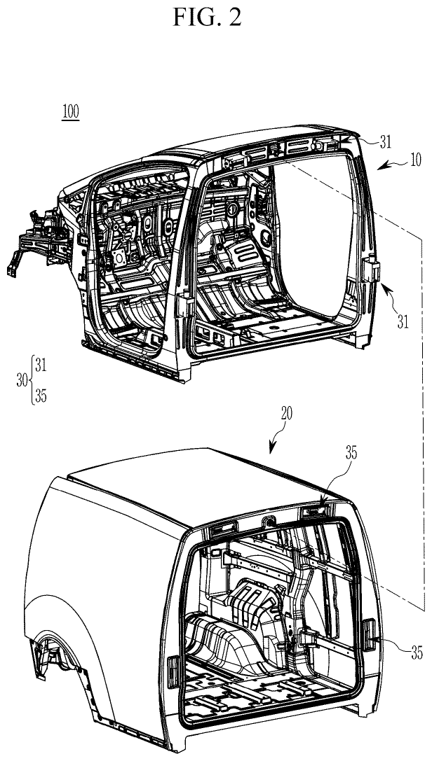

FIG. 1 is an exploded perspective view showing a vehicle body joint structure according to an exemplary embodiment.

Referring to FIG. 1, according to an exemplary embodiment, a vehicle body joint structure 100 may be applied, for example, to a purpose-based mobility vehicle (hereinafter referred to as ‘PBV’).

The PBV may be used as an electric vehicle-based life module vehicle that provides various services to occupants while moving from one place to a destination in an unmanned self-driving manner.

In one example, the PBV may be manufactured in a one box type design with a large interior space. The PBV may also apply facing type seats to the interior space.

The vehicle body of such a PBV is suitable for small quantity production of various vehicle types with a small number of parts and may be manufactured in various shapes and sizes.

The vehicle body of the PBV includes a skateboard type under body 1 (commonly referred to as a ‘rolling chassis’ or ‘chassis frame’ by those skilled in the art) and an upper body 3 assembled to the under body 1.

The under body 1 may be equipped with components such as a battery assembly and a drive motor. Additionally, the upper body 3 may include a spacious cabin and luggage room.

In this specification, the ‘front to rear direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

In this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The vehicle body joint structure 100 according to an exemplary embodiment may be a structure that can apply various types of the upper body 3 to the under body 1 according to the type of customized service of the PBV.

The vehicle body joint structure 100 according to an exemplary embodiment includes a front body module 10 and a rear body module 20 as the upper body 3.

In an exemplary embodiment, the front body module 10 includes a front cabin of a cab type. The front body module 10 may be fixed to the front part of the under body 1.

The front body module 10 may be connected to the front part of the under body 1 along a vertical direction through a vehicle body mounting unit known to a person of ordinary skill in the art. The front body module 10 may be provided as a fixed part 10a fixed to the front part of the under body 1.

The front body module 10 as described above includes a front side structure, a front roof structure, and a front floor structure that are combined with each other.

In an exemplary embodiment, the rear body module 20 includes a rear cabin or a luggage room. The rear body module 20 may be removably provided at the upper part of the under body 1 and the rear part of the front body module 10.

The rear body module 20 may be attached and detached from the rear part of the under body 1 along the vertical direction. Also, the rear body module 20 may be attached and detached to the rear of the front body module 10 in the front to rear direction of the vehicle body. The rear body module 20 may be manufactured in various shapes depending on the purpose of the PBV.

The rear body module 20 may be provided as a detachable variable part 20a at the rear of the under body 1 and the rear of the front body module 10.

The rear body module 20 may form a rear cabin at the rear of the vehicle body. Additionally, the rear body module 20 may form a hailing type upper body 3 together with the front body module 10.

The rear body module 20 may form a luggage room at the rear of the vehicle body. Additionally, the rear body module 20 may form the upper body 3 of a delivery type together with the front body module 10.

The rear body module 20 as described above includes a rear side structure, a rear roof structure, and a rear floor structure that are combined with each other.

FIG. 2 is an exploded perspective view showing a front body module and a rear body module applied to the vehicle body joint structure according to an exemplary embodiment.

Referring to FIG. 1 and FIG. 2, according to an exemplary embodiment, the vehicle body joint structure 100 includes joint units 30.

In an exemplary embodiment, the joint units 30 are configured to attach and detach the front body module 10 and the rear body module 20 in the front to rear direction of the vehicle body. And, the joint units 30 are configured to attach and detach the rear body module 20 to the rear part of the under body 1 along the vertical direction.

The joint units 30 are installed on a rear edge of the front body module 10, a rear of the under body 1, and a front edge and a rear lower part of the rear body module 20.

In one example, the joint units 30 may include a plurality of fixed part joints 31 and a plurality of variable part joints 35.

The fixed part joints 31 may be installed at the rear edge portion of the front body module 10 and the rear part of the under body 1. The variable part joints 35 may be installed on the front edge and the rear lower part of the rear body module 20.

The fixed part joints 31 and the variable part joints 35 may be joined with each other or separated from each other. In one example, the fixed part joints 31 and the variable part joints 35 may be mechanically locked or unlocked by manual or automatic methods.

In another example, the fixed part joints 31 and the variable part joints 35 may be locked or unlocked mechanically and may also be locked or unlocked by magnetic force and electromagnetic force.

In another such example, the fixed part joints 31 may include a magnetic module including a combination of a circular magnet, a linear magnet, a coil, and a locking member that rotates by operation of a motor. In addition, the variable part joints 35 are locked or unlocked with the fixed part joints 31 by magnetic force and electromagnetic force generated from the fixed part joints 31, and the armature block (e.g., steel block) is mechanically locked or unlocked with the locking member.

In addition, the fixed part joints 31 and the variable part joints 35 may be structured so that they can be mutually locked or unlocked in various ways that are obvious to those skilled in the art.

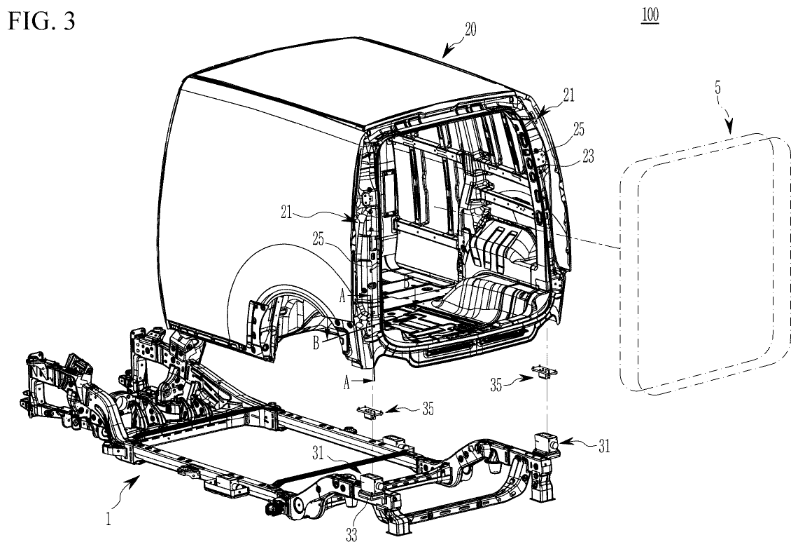

FIG. 3 is an exploded perspective view of the rear body module and an under body applied to the vehicle body joint structure according to an exemplary embodiment.

Referring to FIG. 3, the rear body module 20 as described above includes rear pillar assemblies 21 provided on both sides of the rear portion in the vehicle width direction.

The rear pillar assembly 21 is disposed along the vertical direction and is configured to support the side structure and the roof structure of the rear body module 20. This rear pillar assembly 21 includes a pillar inner member 23 and a pillar outer member 25 that are coupled to each other.

The rear pillar assembly 21 may be attached and detached to the rear part of the under body 1 by the fixed part joints 31 and the variable part joints 35. The fixed part joints 31 are mounted on the rear part of the under body 1, and the variable part joints 35 are mounted on the lower part of the rear pillar assembly 21.

The fixed part joints 31 are mounted on a side of the under body 1 at the rear of the under body 1. The vehicle body joint structure 100 according to an exemplary embodiment may further include a mount bracket 33 connected to the side of the under body 1, on which the fixed part joints 31 are mounted.

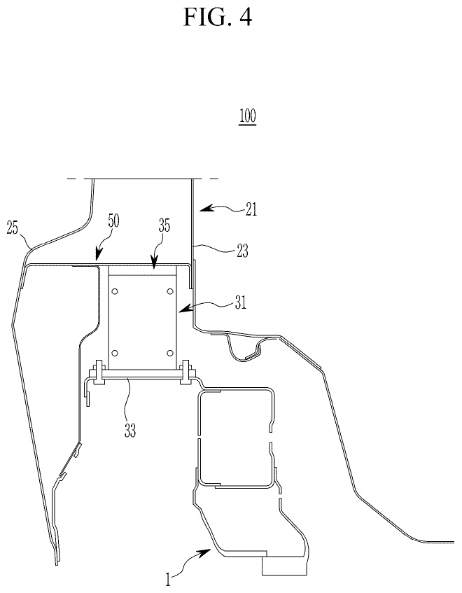

FIG. 4 is a cross-sectional view of the rear body module and the under body applied to the vehicle body joint structure according to an exemplary embodiment.

Referring to FIG. 4, the rear pillar assembly 21 of the rear body module 20 may be fixed to the rear part of the under body 1 by joint combination of the fixed part joints 31 and the variable part joints 35 in the vertical direction.

The rear body module 20 further includes a tail gate assembly 5 mounted on a rear end. The tail gate assembly 5 may be rotatably mounted on both sides along the vehicle width direction through a hinge mechanism at the rear end of the rear body module 20.

The vehicle body joint structure 100 according to an exemplary embodiment as shown in FIG. 4 further includes a joint mounting reinforcement unit 50 mounted on the lower inner side of the rear pillar assembly 21.

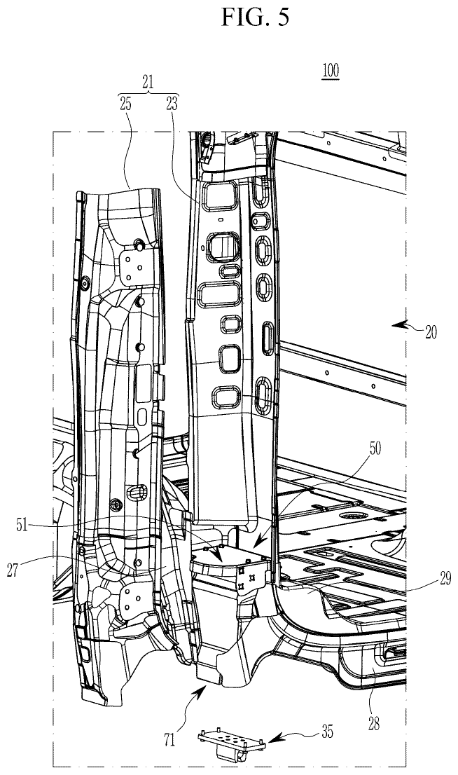

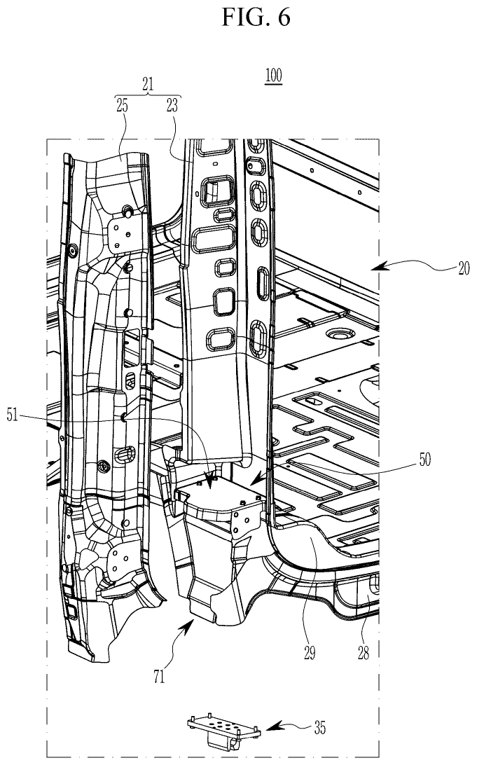

FIG. 5 and FIG. 6 are perspective views showing a joint mounting reinforcement unit applied to the vehicle body joint structure according to an exemplary embodiment.

Referring to FIG. 4 to FIG. 6, the joint mounting reinforcement unit 50 according to an exemplary embodiment is connected to the inner surface of the pillar inner member 23 and the pillar outer member 25 on the lower inner side of the rear pillar assembly 21 and may be connected with the variable part joints 35.

This joint mounting reinforcement unit 50 is configured to reinforce the mounting strength of the variable part joints 35. In addition, the joint mounting reinforcement unit 50 is configured to disperse the load concentrated on the fixed part joints 31 and the variable part joints 35 in the front-back direction of the vehicle body, the vehicle width direction, and the vertical direction.

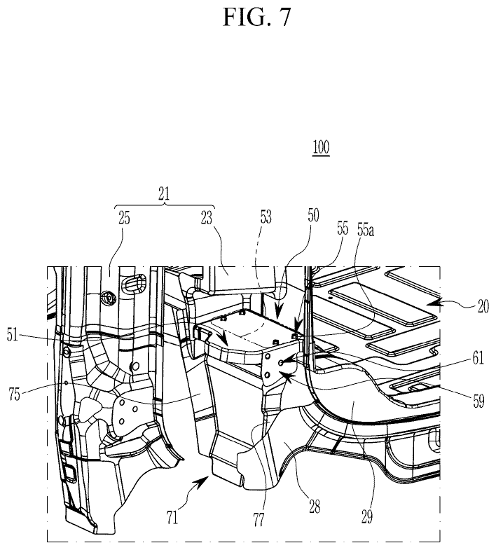

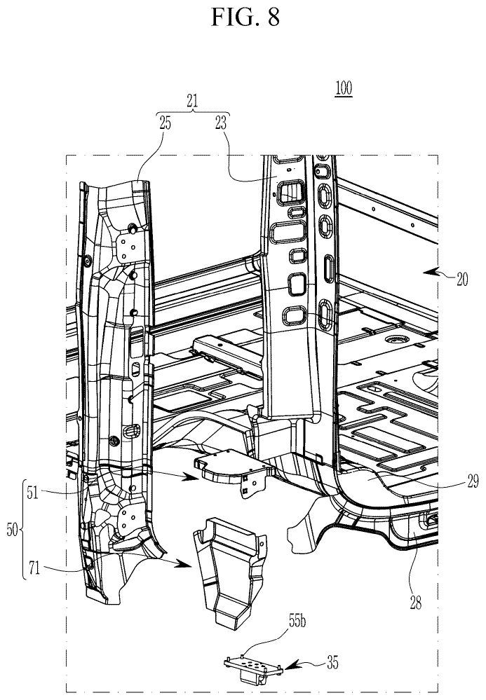

FIG. 7 is an enlarged drawing of the joint mounting reinforcement unit applied to the vehicle body joint structure according to an exemplary embodiment, and FIG. 8 is an exploded perspective view showing the joint mounting reinforcement unit applied to the vehicle body joint structure according to an exemplary embodiment.

Referring to FIG. 5 to FIG. 8, the joint mounting reinforcement unit 50 according to an exemplary embodiment includes a reinforcement member 51 and a lower support member 71.

The reinforcement member 51 is connected to the inner surfaces of the pillar inner member 23 and the pillar outer member 25 on the lower inner side of the rear pillar assembly 21. In one example, the reinforcement member 51 may be provided as a bulk head with a flange extending in a downward direction from an edge of the upper surface. The variable part joints 35 may be coupled to the lower part of the reinforcement member 51.

The reinforcement member 51 includes a joint combined section 53 where the variable part joints 35 are connected at the bottom. The variable part joints 35 may be connected to the joint combined section 53 on the lower side of the reinforcement member 51. For this purpose, fastening members 55 are mounted on the joint combined section 53.

The fastening members 55 may include weld nuts 55a mounted on an upper side of the reinforcement member 51. The variable part joints 35 are disposed in the joint combined section 53 on the lower side of the reinforcement member 51 and may be engaged with the weld nuts 55a through bolts 55b.

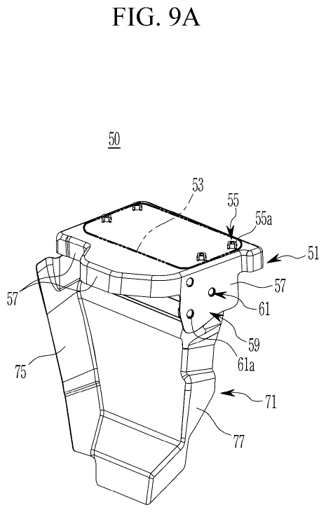

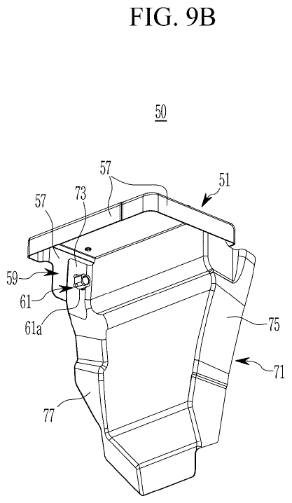

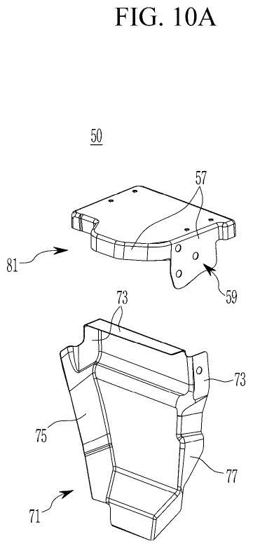

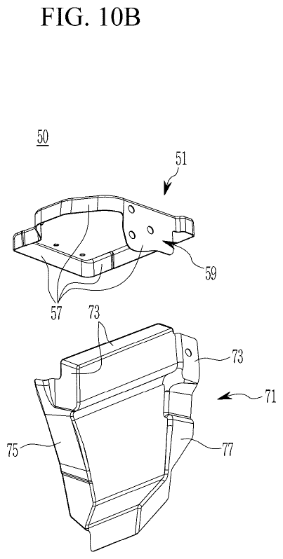

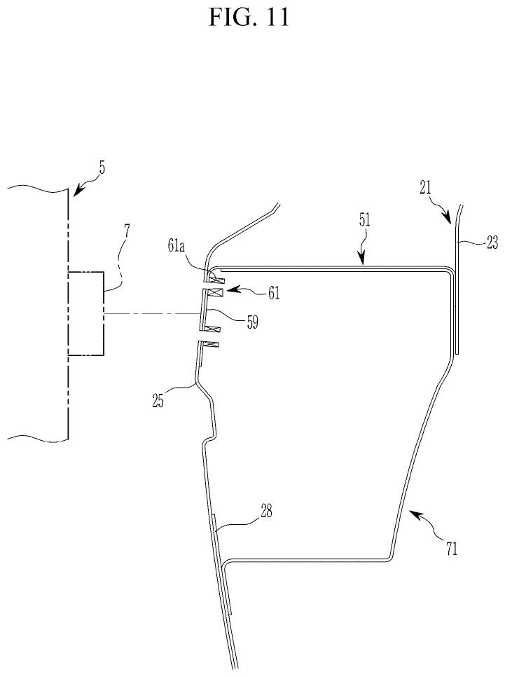

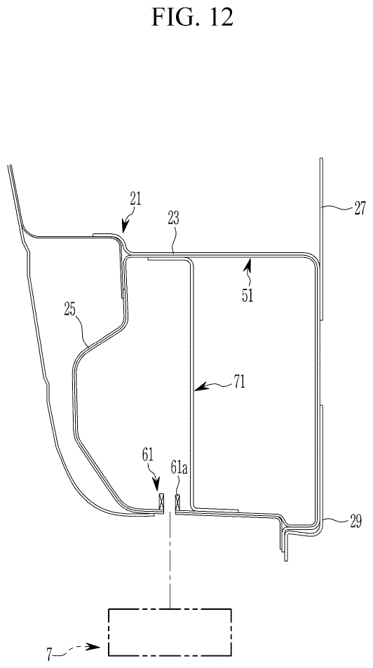

FIG. 9A to FIG. 10B are drawings showing a reinforcement member and a lower support member of the joint mounting reinforcement unit applied to the vehicle body joint structure according to an exemplary embodiment. FIG. 11 is a cross-sectional view along line A-A in FIG. 3, and FIG. 12 is a cross-sectional view along line B-B in FIG. 3.

Referring to FIG. 5 to FIG. 8 and FIG. 9A to FIG. 12, the reinforcement member 51 according to an exemplary embodiment further includes pillar combined flanges 57 formed at the edge portion.

The pillar combined flanges 57 are configured to connect the reinforcement member 51 to the inner surfaces of the pillar inner member 23 and the pillar outer member 25. The pillar combined flanges 57 extend from the upper surface edge of reinforcement member 51 in the lower direction.

One of the pillar combined flanges 57 may be provided as a tail gate mount portion 59 that engages with the tail gate assembly 5. The tail gate mount portion 59 overlaps with the pillar outer member 25 and the lower support member 71 and may engage with the hinge mechanism 7 of the tail gate assembly 5.

The tail gate mount portion 59 is disposed between the pillar outer member 25 and the lower support member 71, and fastening members 61 are installed in the tail gate mount portion 59.

The fastening members 61 may include weld nuts 61a mounted on the tail gate mount portion 59. The hinge mechanism 7 of the tail gate assembly 5 may be engaged with the weld nuts 61a through bolts (not shown) on the outside of the rear pillar assembly 21.

And, the lower support member 71 according to an exemplary embodiment is disposed on the lower side of the reinforcement member 51 and is connected to the lower surface of the reinforcement member 51. The lower support member 71 is connected with the inner surfaces of the pillar inner member 23 and the pillar outer member 25.

The lower support member 71 includes a first combined flange portion 73, a second combined flange portion 75, and a third combined flange portion 77.

The first combined flange portion 73 is formed at an upper part of the lower support member 71. The first combined flange portion 73 is combined with the lower part of reinforcement member 51.

The second combined flange portion 75 is formed at one end of the lower support member 71. The second combined flange portion 75 is combined with the pillar inner member 23.

And, the third combined flange portion 77 is formed on the other end of the lower support member 71. The third combined flange portion 77 is combined with the pillar outer member 25.

As shown in FIG. 5, the vehicle body joint structure 100 according to an exemplary embodiment may further include a wheel house inner member 27 provided on the rear side portion of the rear body module 20 to which the second combined flange portion 75 of the lower support member 71 is connected.

As shown in FIG. 7, the vehicle body joint structure 100 according to an exemplary embodiment may further include a back panel 28 disposed along the vehicle width direction at the rear lower part of the rear body module 20 to which the third combined flange portion 77 of the lower support member 71 is connected.

In the vehicle body joint structure 100 according to an exemplary embodiment, the rear body module 20 further includes a back panel extension member 29 connected to the back panel 28.

The back panel extension member 29 is connected with the pillar inner member 23 of the rear pillar assembly 21.

Hereinafter, referring to FIG. 1 to FIG. 12, the operation of the vehicle body joint structure 100 according to an exemplary embodiment configured as above will be explained in detail.

In an exemplary embodiment, the front body module 10 is fixed to the front part of the under body 1. And, the rear body module 20 is separate from the front body module 10.

The fixed part joints 31 of the joint unit 30 are installed at the rear edge of the front body module 10 and the rear portion of the under body 1. The fixed part joints 31 disposed at the rear of the under body 1 are mounted on the mount bracket 33 connected to the side of the under body 1.

The variable part joints 35 of the joint unit 30 are coupled to the front part and rear lower part of the rear body module 20. The variable part joints 35 are mounted on the rear lower part of the rear body module 20 and the lower part of the rear pillar assembly 21.

The joint mounting reinforcement unit 50 is coupled to the inner surfaces of the pillar inner member 23 and the pillar outer member 25 on the lower inner side of the rear pillar assembly 21.

The joint mounting reinforcement unit 50 includes the reinforcement member 51 and the lower support member 71. The reinforcement member 51 is coupled to the inner surfaces of the pillar inner member 23 and the pillar outer member 25. The lower support member 71 is coupled to the lower surface of the reinforcement member 51 and the inner surfaces of the pillar inner member 23 and the pillar outer member 25.

The variable part joints 35 are engaged at the lower side of the reinforcement member 51 to the joint combined section 53 of the reinforcement member 51. The hinge mechanism 7 of the tail gate assembly 5 is engaged to the tail gate mount portion 59 of the reinforcement member 51 that overlaps with the pillar outer member 25 and the lower support member 71.

The lower support member 71 is connected to the wheel house inner member 27 and the back panel 28. The back panel 28 and the pillar inner member 23 are connected through the back panel extension member 29.

In this state, the rear body module 20 moves from the rear side of the under body 1 to the lower direction and moves toward the front body module 10. Then, the fixed part joints 31 as described above are jointly combined with the variable part joints 35.

The fixed part joints 31 installed on the rear edge of the front body module 10 can be combined with the variable part joints 35 installed on the front edge of the rear body module 20 in the front to rear direction of the vehicle body.

In addition, the variable part joints 35 installed on the joint mounting reinforcement unit 50 on the lower inner side of the rear pillar assembly 21 can be joined with the fixed part joints 31 installed on the rear part of the under body 1 along the vertical direction.

Therefore, the front body module 10 and the rear body module 20 can be combined in the front to rear direction of the vehicle body through the fixed part joints 31 and the variable part joints 35. In addition, the rear body module 20 can be coupled to the rear part of the under body 1 along the vertical direction through the fixed part joints 31 and the variable part joints 35.

As described above, the vehicle body joint structure 100 according to an exemplary embodiment can reinforce the mounting strength of the variable part joints 35 mounted on the rear pillar assembly 21 of the rear body module 20 through the joint mounting reinforcement unit 50.

In addition, the vehicle body joint structure 100 according to an exemplary embodiment can disperse the load concentrated on the fixed part joints 31 and the variable part joints 35 in multiple directions through the joint reinforcement mounting unit 50.

The joint mounting reinforcement unit 50 can disperse the load in the vertical direction through the rear pillar assembly 21. The joint mounting reinforcement unit 50 can disperse the load in the front and rear direction of the vehicle body through the wheel house inner member 27. The joint mounting reinforcement unit 50 can disperse the load in the vehicle width direction through the back panel 28 and the back panel extension member 29.

The joint mounting reinforcement unit 50 can be combined with the tail gate assembly 5 and secure the mounting strength of the tail gate assembly 5.

According to the vehicle body joint structure 100 according to an exemplary embodiment, in a state where the front body module 10 as the fixed part 10a coupled to the front part of the under body 1 is mounted, the rear body module 20 as the variable part 20a is attached to the rear part of the under body 1 and the front body module 10.

Therefore, according to the vehicle body joint structure 100 according to an exemplary embodiment, the rear body module 20 of a predetermined shape can be replaced depending on the type of customized service (e.g., use case) of the PBV, and thus, the PBV can be used as a hailing type or delivery type vehicle.

As a result, the vehicle body joint structure 100 according to an exemplary embodiment can reduce the cost of configuring the vehicle body to suit the various customized services of the PBV.

While embodiments of this invention have been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A joint structure of a vehicle body, the joint structure comprising:
a front body module comprising a fixed part fixed to a front part of an under body;
a rear body module comprising a variable part detachably coupled to a rear part of the under body and a rear part of the front body module, the rear body module having a predetermined shape;
fixed part joints disposed at a rear edge of the front body module and at a rear of the under body;
variable part joints disposed on a front edge and a rear lower part of the rear body module and connected with the fixed part joints; and
a joint mounting reinforcement unit disposed on a lower inner side of a rear pillar assembly disposed on both sides of the rear part of the rear body module and connected with the variable part joints.

2. The joint structure of claim 1, wherein:
the rear pillar assembly comprises a pillar inner member and a pillar outer member connected together; and
the joint mounting reinforcement unit is connected to inner surfaces of the pillar inner member and the pillar outer member.

3. The joint structure of claim 1, further comprising a mount bracket connected to a side of the under body, wherein the fixed part joints disposed at the rear of the under body are mounted on the mount bracket.

4. The joint structure of claim 1, wherein the joint mounting reinforcement unit comprises:
a reinforcement member, wherein the reinforcement member is connected to inner surfaces of a pillar inner member and a pillar outer member on the lower inner side of the rear pillar assembly including the pillar inner member and the pillar outer member connected together, and wherein the reinforcement member is connected with the variable part joints; and
a lower support member connected to a lower part of the reinforcement member and connected to the pillar inner member and the pillar outer member.

5. The joint structure of claim 4, wherein:
the reinforcement member comprises a joint combined section where the variable part joints are combined; and
fastening members are disposed on the joint combined section.

6. The joint structure of claim 4, wherein the reinforcement member comprises pillar combined flanges disposed on edge portions and configured to be connected with the inner surfaces of the pillar inner member and the pillar outer member.

7. The joint structure of claim 6, wherein one of the pillar combined flanges overlaps with the pillar outer member and the lower support member and is a tail gate mount portion that engages with a tail gate assembly.

8. The joint structure of claim 7, further comprising fastening members disposed in the tail gate mount portion.

9. The joint structure of claim 4, wherein the lower support member comprises:
a first combined flange portion combined with the lower part of the reinforcement member;
a second combined flange portion combined with the pillar inner member; and
a third combined flange portion combined with the pillar outer member.

10. The joint structure of claim 4, further comprising a back panel disposed along a vehicle width direction at the rear lower part of the rear body module, wherein the lower support member is connected to the back panel.

11. The joint structure of claim 4, further comprising a wheel house inner member disposed on a rear side of the rear body module, wherein the lower support member is connected to the wheel house inner member.

12. The joint structure of claim 1, further comprising a back panel extension member connected to a back panel disposed along a vehicle width direction at the rear lower part of the rear body module and connected to a pillar inner member of the rear pillar assembly.

13. A vehicle comprising:
a vehicle body comprising an under body, a front body module coupled to a front part of the under body, and a rear body module detachably coupled to a rear part of the under body and a rear part of the front body module;
a rear pillar assembly disposed on both sides of a rear part of the rear body module;
fixed part joints disposed at a rear edge of the front body module and at a rear of the under body;
variable part joints disposed on a rear lower part of the rear body module and a lower part of the rear pillar assembly, wherein the variable part joints are connected with the fixed part joints; and
a joint mounting reinforcement unit disposed on a lower inner side of the rear pillar assembly and connected with the variable part joints.

14. The vehicle of claim 13, further comprising a mount bracket connected to a side of the under body, wherein the fixed part joints disposed at the rear of the under body are mounted on the mount bracket.

15. The vehicle of claim 13, wherein the rear pillar assembly comprises a pillar inner member and a pillar outer member connected together.

16. The vehicle of claim 15, wherein the joint mounting reinforcement unit comprises:
a reinforcement member coupled to inner surfaces of the pillar inner member and the pillar outer member; and
a lower support member coupled to a lower surface of the reinforcement member and the inner surfaces of the pillar inner member and the pillar outer member.

17. The vehicle of claim 16, wherein:
the reinforcement member comprises a joint combined section where the variable part joints are combined; and
fastening members are disposed on the joint combined section.

18. The vehicle of claim 16, wherein the reinforcement member comprises pillar combined flanges disposed on edge portions and configured to be connected with the inner surfaces of the pillar inner member and the pillar outer member.

19. The vehicle of claim 18, wherein:
one of the pillar combined flanges overlaps with the pillar outer member and the lower support member and is a tail gate mount portion that engages with a tail gate assembly; and
fastening members are disposed in the tail gate mount portion.

20. The vehicle of claim 16, further comprising:
a back panel disposed along a vehicle width direction at the rear lower part of the rear body module, wherein the lower support member is connected to the back panel;
a wheel house inner member disposed on a rear side of the rear body module, wherein the lower support member is connected to the wheel house inner member; and
a back panel extension member connected to the back panel and connected to the pillar inner member of the rear pillar assembly.
